(19) United States
(12) Patent Application Publication
(10) Pub. No.: US 2003/0083942 A1
(43) Pub. Date: May 1, 2003

(54) Method of enhancing the security of a protection mechanism

(76) Inventors: Willem Charles Mallon, Eindhoven (NL); Joachim Artur Trescher, Eindhoven (NL); Paulus Mathias Hubertus Mechtildus Antonius Gorissen, Eindhoven (NL)

Correspondence Address: U.S. Philips Corporation, 580 White Plains Road, Tarrytown, NY, 10591, US

(21) Appl. No.: 10/274,400

(22) Filed: Oct. 18, 2002

(30) Foreign Application Priority Data
Oct. 23, 2001 (EP) 01204019.2

(51) Int. Cl. G06F 17/60; H04L 9/00; H04L 9/32; G06F 11/30; G06F 12/14

(52) U.S. Cl. 705/14; 713/201

(57) ABSTRACT

A method of enhancing the security of a protection mechanism used in a product. When information (115) regarding a vulnerability in the protection mechanism is received from a person (100), the person (100) is given a reward (145) for supplying the information (115). The reward (145) comprises a portion of profits made on the product in a time period ranging from the moment of receiving the information (115) until a moment at which the information (115) becomes public knowledge.

The invention relates to a method of enhancing the security of a protection mechanism used in a product, comprising receiving information regarding a vulnerability in the protection mechanism from a person and giving the person a reward for supplying the information.

The physical protection of data such as confidential or secret information against unauthorized access, or the protection of copyrighted works against unauthorized duplication is relatively easy. Access to the works can be restricted, and making copies requires relatively large and expensive installations. If a vulnerability in such a physical protection scheme is detected, it can be fixed and the security of the protection is enhanced. For example, a weak door lock can be replaced with a stronger one.

Copying of valuable information in electronic form, such as software, music, movies and so on has become increasingly easy in the last few years, because making copies takes almost no effort and very little equipment. Although copyright law prohibits the unauthorized copying of copyrighted works, it is very difficult to prevent such unauthorized copying in practice. To overcome this problem, many different protection mechanisms have been designed that make copying difficult, if not impossible.

Encryption can be used to protect against unauthorized copying—by supplying the secret information only to entities who are authorized to make copies—as well as to protect against unauthorized access to the information. Digital rights management systems and copy protection schemes have been devised based on encryption techniques, often in combination with authentication mechanisms. Other copy protection schemes employ watermarking techniques to embed restrictions on copying in a work in digital form.

While all these methods do provide some form of protection, this protection is not perfect. Vulnerabilities in encryption schemes, watermarking techniques and so on are discovered all the time. By exploiting such a vulnerability, it becomes possible to gain unauthorized access to and/or to make unauthorized copies of a protected product.

If information regarding the vulnerability is supplied to the vendor of the product, or to the supplier of the protection mechanism, then the vendor or supplier can work on fixing the vulnerability. Vendors sometimes promise rewards to people who supplied them with information regarding vulnerabilities, in order to encourage supplying such information. For example, the Dutch Internet provider XS4All offers a free six month subscription to any person who manages to obtain superuser privileges on its computer systems, provided that the person reveals to them how he gained these privileges and did not cause any damage on the systems.

Unfortunately, many vendors and suppliers have proven to be rather slow or ineffective in fixing vulnerabilities. This has caused many people who discover vulnerabilities to publish their information to create public awareness of the problem. The public awareness then serves as an incentive to the vendor or supplier to quickly fix the problem. It also provides others a means to exploit the vulnerability. So, it is desirable from the vendor's point of view that the information is kept confidential, while at the same time it is desirable that the vulnerability is fixed quickly.

It is an object of the invention to provide a method according to the preamble, which encourages keeping the information confidential while providing an incentive to the recipient of the information to quickly fix the vulnerability.

This object is achieved according to the invention in a method which is characterized in that the reward comprises a portion of profits made on the product in a time period ranging from the moment of receiving the information until a moment at which the information becomes public knowledge.

Sharing in the profits made on the product is a very attractive reward to the person submitting the information, since these profits can be potentially very large. By limiting the period during which the reward is supplied in the above fashion, it becomes in the person's own interest to keep the information confidential as long as possible.

At the same time, having to share some of the profits with a person who reported a vulnerability is a good incentive to the vendor or creator to fix the vulnerability. When the vulnerability has been fixed, the vendor or creator could publish the vulnerability information as well as the fix to inform the public and to end the sharing of the profits.

In an embodiment the method further comprises verifying, based on the information, that the vulnerability in fact exists in the protection mechanism, and giving the reward to the person only upon a successful verification. It is preferred that only reports regarding actual vulnerabilities that exist in practice are rewarded by sharing profits. Reports regarding theoretical vulnerabilities and problems that may become apparent in the future are of course also useful, but less than the reports regarding actual vulnerabilities in the product that is on the market right now.

In a further embodiment the method comprises giving the reward only to the first person who supplies the information. This encourages quick submission of the information to the product vendor.

In a further embodiment the method further comprises registering the person in a database upon receiving the information. By registering persons who submit vulnerability information, the product vendor can identify persons who have made substantial contributions to the security of the protection mechanism. The vendor could then for instance offer these persons a job as security officer responsible for the protection mechanism.

In a variant of the above embodiment the method further comprises increasing the portion dependent on the number of times the person has been registered in the database. This encourages the person to also submit information regarding other vulnerabilities.

In a further embodiment the method comprises receiving the information regarding one vulnerability from plural persons, and sharing the portion between the plural persons. This way, all the persons who have the information are now encouraged to keep the information confidential. It also discourages receiving the information to a select number of other persons so that these other persons also get the reward. By doing so in this embodiment the level of the reward for each person is reduced for every additional person who reports the vulnerability.

In a further embodiment the protection mechanism is one of a copy protection mechanism, an encryption scheme, an authentication scheme, a watermarking technique and a digital rights management system.

In a further embodiments the reward is given in the form of electronic money. This has the advantage that it can be supplied to the person—and spent by the person—even if the person remains anonymous. This way, the person does not have to fear legal actions in return for supplying the information regarding the vulnerability.

These and other aspects of the invention will be apparent from and elucidated with reference to the drawing, in which:

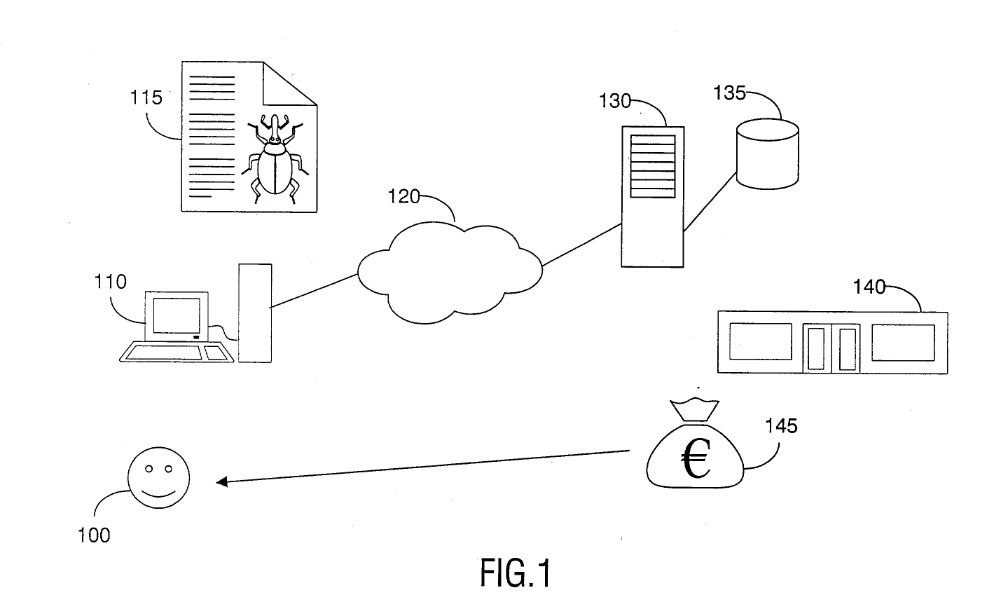

FIG. 1 schematically shows a system comprising a product vendor and a person.

FIG. 1 schematically shows a system comprising a product vendor 140 and a person 100. The product vendor 140 sells or otherwise makes available a product in electronic form. The product can be for instance an audiovisual work such as a movie or song, or a computer program.

To guard against unauthorized access and/or copying, the product vendor 140 employs a protection mechanism. This protection mechanism could be, for instance, a copy protection mechanism, an encryption scheme, an authentication scheme, a watermarking technique or a digital rights management system. Exactly how this protection mechanism is applied to the product depends on the type of protection mechanism and the type of product. For example, an audiovisual work could be protected by encrypting it or by embedding watermark information in it. A computer program could be protected by providing an installation routine that verifies the presence of an electronic license file or requires a user to input a unique code. A portion of the code could also be intentionally obfuscated, that is, written in a way that is hard to understand for humans so that it becomes more difficult to understand its workings and discover potential weaknesses or vulnerabilities.

The protection mechanism could have been developed by the product vendor 140 itself, or by a third party which has licensed it to the product vendor 140. In this example, the product vendor 140 developed the protection mechanism itself. Often the protection mechanism comprises one more computer programs.

As it turns out, however, a vulnerability exists in the protection mechanism. The vulnerability could lie in many different aspects of the protection mechanism. For instance, the encryption scheme used may be flawed, the secret key necessary to decrypt the product may be exposed in whole or in part, the watermark used to embed copy restrictions could be easily removed, and so on. Many examples of vulnerabilities in protection mechanisms are known in the art. An extensive list, titled “Common Vulnerabilities and Exposures”, can be found on the Internet at the address http://www.cve.mitre.org/cve/ and is provided by the MITRE Corporation. The Computer Emergency Response Team (CERT) publishes advisories on newly discovered vulnerabilities, available on the Internet at the address http://www.cert.org/advisories/.

When vulnerabilities in physical protection schemes are discovered, they can be fixed and then the security of the protection scheme is restored. The protection mechanism, as well as the objects protected by it, are under the control of the vendor and/or user. For example, a weak door lock in a door leading to a restricted area can be replaced by the lock vendor or by the controller of the area. With copy protection mechanisms and the likes, this is much more difficult. When a vulnerability in the mechanism is discovered, products in which the mechanism is used are generally already on the market. It is then next to impossible to restore the security of those protected products.

If a vulnerability is discovered in such a protection mechanism, it is very likely that information regarding the vulnerability will become public, and then it will be exploited by a large number of people. This has a direct impact on the profits made on selling the product. For instance, if a digital music copy protection scheme is cracked, the music can be copied freely, and so fewer people will buy a copy of the music. Thus, it is in the interest of the vendor of the product that details regarding the vulnerability are kept secret for the longest possible time.

In FIG. 1, the person 100 has just discovered this vulnerability. He creates a message 115 explaining what the vulnerability is, how it can be reproduced and preferably also how it can be fixed. The person 100 then gives the message 115 to the product vendor 140, since this is the entity responsible for fixing the vulnerability. In a preferred embodiment the person 100 uses his computer 110 to transmit the message 115 electronically to a server 130 via a network 120 such as the Internet, e.g. as an e-mail message. Alternatively, the person 100 could dial into a bulletin board system maintained by server 130, make a phone call or send a paper letter.

If the protection mechanism had instead been developed by a third party, the person 100 could have given the message 115 to the third party. However, the person 100 could in this case still submits the message 115 to the product vendor 140 since this is the entity from which he obtained the product.

The server 130 can perform some basic checking on the message 115. For example a standardized format could be required for the submission of information regarding vulnerabilities. The server 130 then checks whether the message 115 is in compliance with the standardized format. It can also check whether the message 115 refers to the latest version of the protection mechanism, to avoid handling messages regarding vulnerabilities that have already been fixed.

In a preferred embodiment wherein message 115 contains instructions on how the vulnerability can be fixed, the server 130 can automatically apply these instructions to the protection mechanism. A popular way to distribute fixes, additions and updates to software products is by using so-called patch files. A patch file contains changes that need to be made to a computer program, in a format that can be processed automatically by a computer. This makes this format well suited for supplying instructions on how to fix the vulnerability.

While the server 130 may be able to automatically apply the patch to the protection mechanism, it will still be necessary for a human to verify the correctness of the patch and the fact that it fixes the vulnerability. Additionally, it is desirable to verify that the vulnerability in fact exists in the product before fixing it.

Having received the message 115, the vendor 140 is now in a position to fix the vulnerability. To thank the person 100 who supplied the message 115, the vendor 140 supplies a reward 145 in the form of money to the person 100. The reward 145 can comprise “real” money or electronic money. The latter type has the advantage that it can be supplied to the person 100—and spent by the person 100—even if the person 100 remains anonymous. This way, the person 100 does not have to fear legal actions in return for supplying the message 115.

The reward 145 comprises a portion of profits made on the product protected by the vulnerable protection mechanism. This portion could be for example a percentage or a fixed amount. The profits made on the product are preferably a portion of the selling price of the product, that is, its profit margin. However, the vendor 140 could also make money off the product in some other way. He could give away the product itself and charge for the use of the product, e.g. by selling licenses with a limited lifetime. Regardless of which method the vendor 140 uses to make money off the product, a portion of this money is profit.

To encourage the person 100 to keep his discovery of the vulnerability confidential, the reward 145 is supplied to the person 100 until such time as the vulnerability becomes public knowledge. The reward 145 can be computed for instance as a percentage of profits on a monthly or weekly basis.

The reward 145 can be given only to the first person who supplies the information. This encourages quick submission of the information to the product vendor 140. Alternatively, if the information regarding one and the same vulnerability is received from plural persons, then the portion of the profits will be divided between the plural persons. This way, all the persons who have the information are now encouraged to keep the information confidential.

Upon receiving the information, the person 100 can be registered in a database 135. This can be done automatically by the server 130 or manually upon verification of the message 115. By registering persons who submit vulnerability information, the product vendor 140 can identify persons who have made substantial contributions to the security of the protection mechanism. The vendor 140 could then for instance offer these persons a job as security officer responsible for the protection mechanism.

Additionally, registering the person 100 in a database 135 makes it possible to increase the reward 145 dependent on the number of times the person 100 has been registered in the database 135. This encourages the person 100 to submit information regarding other vulnerabilities.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of enhancing the security of a protection mechanism used in a product, comprising receiving information (115) regarding a vulnerability in the protection mechanism from a person (100) and giving the person (100) a reward (145) for supplying the information (115), characterized in that the reward (145) comprises a portion of profits made on the product in a time period ranging from the moment of receiving the information (115) until a moment at which the information (115) becomes public knowledge.

2. The method of claim 1, further comprising verifying, based on the information (115), that the vulnerability in fact exists in the protection mechanism, and giving the reward (145) to the person (100) only upon a successful verification.

3. The method of claim 1, comprising giving the reward (145) only to the first person (100) who supplies the information (115).

4. The method of claim 1, further comprising registering the person (100) in a database (135) upon receiving the information (115).

5. The method of claim 4, further comprising increasing the portion dependent on the number of times the person (100) has been registered in the database (135).

6. The method of claim 1, comprising receiving the information (115) regarding one vulnerability from plural persons, and sharing the portion between the plural persons.

7. The method of claim 1, wherein the protection mechanism is one of a copy protection mechanism, an encryption scheme, an authentication scheme, a watermarking technique and a digital rights management system.

8. The method of claim 1, wherein the reward (145) is given in the form of electronic money.
